(19) United States
(12) Patent Application Publication
(10) Pub. No.: US 2006/0179428 A1
(43) Pub. Date: Aug. 10, 2006

(54) Method and system for efficiently starting a JAVA application

(76) Inventors: Kiyokuni Kawachiya, Yokohama-shi (JP); Tamiya Onodera, Ageo-shi (JP); Kazunori Ogata, Fujisawa-shi (JP); Hideaki Komatsu, Yokohama-shi (JP)

Correspondence Address: LIEBERMAN & BRANDSDORFER, LLC, 802 STILL CREEK LANE, GAITHERSBURG, MD, 20878, US

(21) Appl. No.: 11/054,899

(22) Filed: Feb. 10, 2005

(51) Int. Cl. G06F 9/45

(52) U.S. Cl. 717/148

(57) ABSTRACT

A method and system are provided for starting a new JAVA application while eliminating overhead associated therewith. The new JAVA application is created from a memory image of an initialized JAVA application. The memory image of the process which is executing the initialized JAVA application is copied to enable the memory image to be observed by the new JAVA application. In addition, to copying the memory image, the states of system resources and operating system monitors not present in the copied memory image are recreated on the JAVA application.

### BACKGROUND OF THE INVENTION

1. Technical Field

This invention relates to a method and system for starting a JAVA application process without having to initialize a new JAVA application. More specifically, a new JAVA application process is created from a memory image of an already initialized JAVA application.

2. Description of the Prior Art

FIG. 1 is a block diagram (10) of a first JAVA application (20) executing a first process (25), and a second JAVA application (40) executing a second process (45). As shown, the first process (25) of the first JAVA application (20) has class structures (30), objects (32), just-in-time (JIT) compiled codes (34), and threads (36). Similarly, the second process (45) of the second JAVA application (40) has class structures (50), objects (52), JIT compiled codes (54), and threads (56). Each application (20) and (40) has its own class structures (30), (50), objects (32), (52), JIT compiled codes (34), (54), and threads (36), (56). To start a new environment without sharing any elements from an existing environment requires the building of each of the elements for each process.

To improve start-up time of a JAVA application, it is known in the art to extract internal data structures from a running JAVA application, and to share the extracted data structure with other JAVA applications. FIG. 2 is a block diagram (70) illustrating creation of a new JAVA application (74) from a first JAVA application (72) by sharing components in the process (76) associated with the first application (72). A first grouping (80) having objects (82), threads (84), and statics (86) is formed in the process (76), and a second grouping (90) having objects (92), threads (94), and statics (96) is also formed in the process (76). Part of the class structures (88) and JIT compiled codes (98) are shared among the first and second groupings (80) and (90). Start up of a new application is faster in comparison to the model shown in FIG. 1 because class loading and JIT-compilation are shared among the first and second applications (72), (74). However, even if class structures and JIT compiled codes are shared, time for initializing an unshared part of classes (86)(96), creating objects (82)(92), and initializing middleware (not shown) are still necessary for both applications (72)(74). Accordingly, there is a need for replication a JAVA application that eliminates overhead associated with the initialization of classes, middleware, and objects.

By eliminating re-initialization of elements of an application, a new application can be created that borrows the image of an existing application. For example, the UNIX operating system has a function that creates a new process by copying the memory image of an operating process. However, there are shortcomings associated with this UNIX function. One such shortcoming is the inability of this UNIX function to copy threads present in an operating process into a new process. There is therefore a need to replicate an existing JAVA application that can borrow the state of an already initialized application. The replication process should include the ability to copy not only the memory image but also the system resources, i.e. threads, of an already initialized application. Following replication, the new application may begin executing from the copied image, thereby eliminating cost associated with initialization of a new JAVA application.

### SUMMARY OF THE INVENTION

This invention comprises a method and system for replicating a JAVA application.

In one aspect of the invention, a method is provided for starting a JAVA application. The method includes two primary steps. A first step includes copying a memory image of a process executing a JAVA execution environment that has completed initialization. The first step is followed by a second step that involves recreating a system resource in the new process if the resource is not present in the copied memory image.

In another aspect of the invention, a computer system is provided with a process executing a JAVA execution environment with a completed initialization. A master image manager is provided to copy a memory image of the process. In addition, a copy image manager is provided to recreate a system resource in the new process if the system resource is not present in the copied memory image.

In yet another aspect of the invention, an article is provided with a computer-readable signal-bearing medium. Means in the medium are provided for copying a memory image of a process executing a JAVA execution environment having a completed initialization. In addition, means in the medium are provided for recreating a system resource not present in the copied memory image in a, new process.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of two JAVA applications running associated processes.

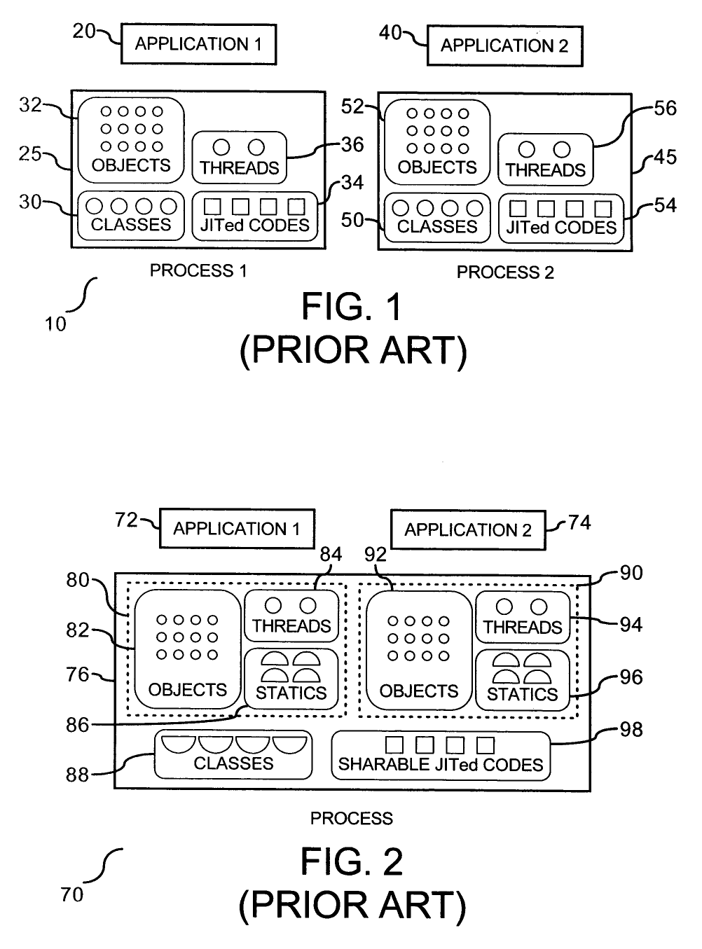

FIG. 2 is a prior art block diagram of a second JAVA application created from shared classes of a process associated with a first JAVA application.

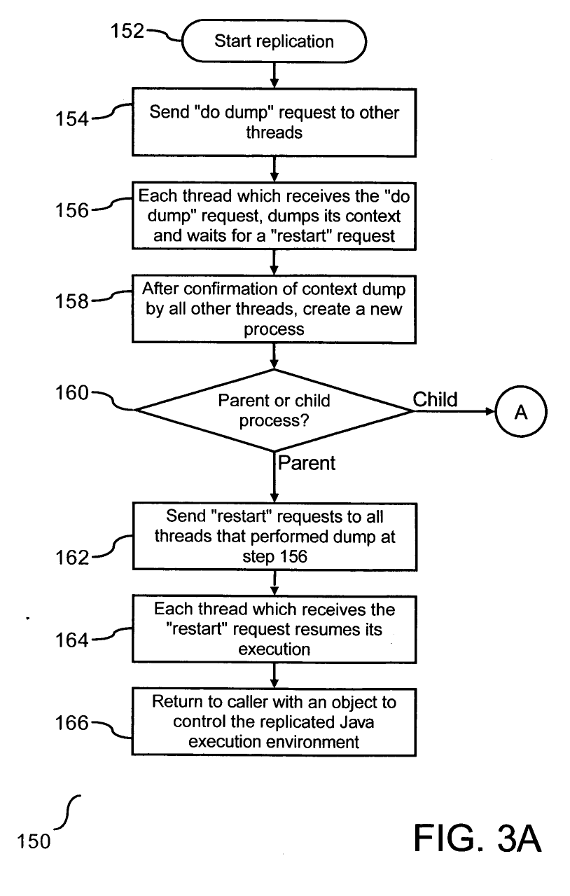

FIGS. 3a and 3b are a flow chart illustrating creation of a new JAVA application according to one embodiment of this invention.

FIG. 4 is a flow chart illustrating creation of a new JAVA application according to a second embodiment of this invention.

FIG. 5 is a block diagram illustrating a general execution of the process for creating a new JAVA application based on the first and second embodiment of this invention, and is suggested for printing on the first page of the issued patent.

### DESCRIPTION OF THE PREFERRED EMBODIMENT

### Overview

A new JAVA execution environment is created from an existing JAVA execution environment having completed its initialization. The new environment is created by recreating the internal state of operations from the existing JAVA execution environment. There are two primary steps associated with creation of the new environment. The first step involves copying the memory image of the existing JAVA execution environment, as this enables the memory image to be observed as in the same address in the new process. The second step involves recreating the states of system resources, including threads and monitors, by using information in the copied memory image.

### Technical Details

Creating a new JAVA execution environment, referred to hereinafter as a child process, based on a master JAVA execution environment, referred to hereinafter as a parent process, requires creating an equivalent process image from the perspective of the operating system. Most of the states of the master environment can be replicated by copying the user memory space of the parent process. The complexity of the reproduction stems from replicating states within the operating system known as system resources. For example, context of threads and internal states of monitors (mutexes) are usually represented in the kernel space of the operating system. A complete replication must include the context of threads and internal states of operating system monitors. There are two processes embodied in replicating the states of the system resources: a dump of a state of a system resource into user space memory, and a log of activities to a system resource in user space memory. Accordingly, prior to copying the memory image of the JAVA execution environment, the state of the system resources must be placed in the user memory space through either of the above referenced processes.

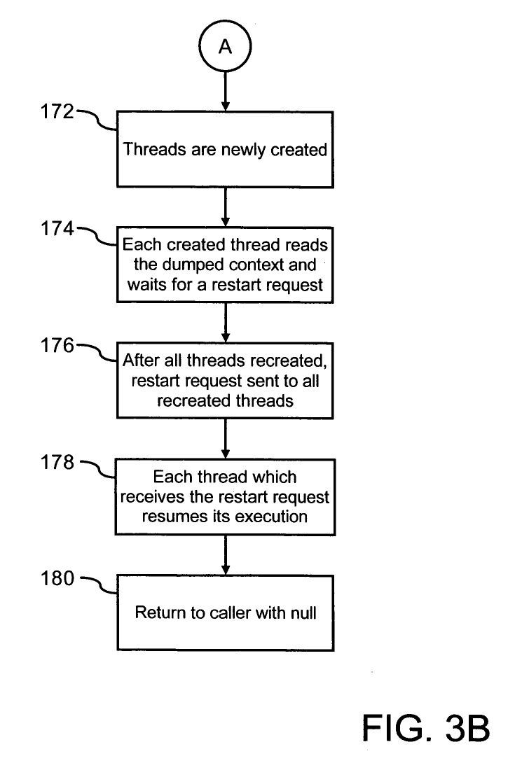

FIGS. 3a and 3b are flow charts (150) illustrating one embodiment of reproducing a JAVA execution environment with use of a dump process to replicate threads. Prior to copying the memory image, the contexts of threads need to be dumped into the user memory. As shown in FIG. 3a, at the beginning of the replication process (152) a dump request is sent to each thread in the parent process (154). Upon receipt of the dump request, each thread that received the command at step (154) dumps its context into user space memory and waits for a restart request to resume operation (156). After confirmation has been received that each of the requested threads has performed the dump command, a new JAVA execution environment, i.e. a child process, is created from the parent process with a copy of the memory of the original environment, i.e. the parent, (158). The memory image can be copied by modifying the memory allocation mechanism of the parent process to allocate all data from shareable segments. One form of a memory management technique that reduces the memory copying overhead is called copy-on-write. This technique supports sharing of physical memory pages in read only mode by both the parent and child processes, instead of copying contents of the memory pages to the child environment. The memory image of the parent process is shared by the parent and the child processes. In this configuration, the number of actual page copies is further reduced by categorizing the data allocation within the Java execution environment such as read-only, read-mostly, and read-write, and then by assigning different memory area to each category.

Following step (158) a test is conducted to determine restart of a parent process or start of a child process (160). In the parent process, a restart request is sent to all threads that performed the dump request (162). Each of the threads that receives the restart request at step (162), resumes execution of processes (164) followed by return of an object to the caller to control the replicated JAVA execution environment, i.e. child process, (166).

In the child process, threads are newly created (172). Each created thread reads the context dumped by step (156) and copied by step (158), and waits to receive a restart request (174). After all threads are recreated, a restart request is sent to all the recreated threads (176). Each thread in receipt of the restart request resumes execution of processes (178), and then a null value is returned (180). Accordingly, system resources, i.e. threads, may be replicated into a child process from a parent process through use of a dump request prior to replication of the memory image.

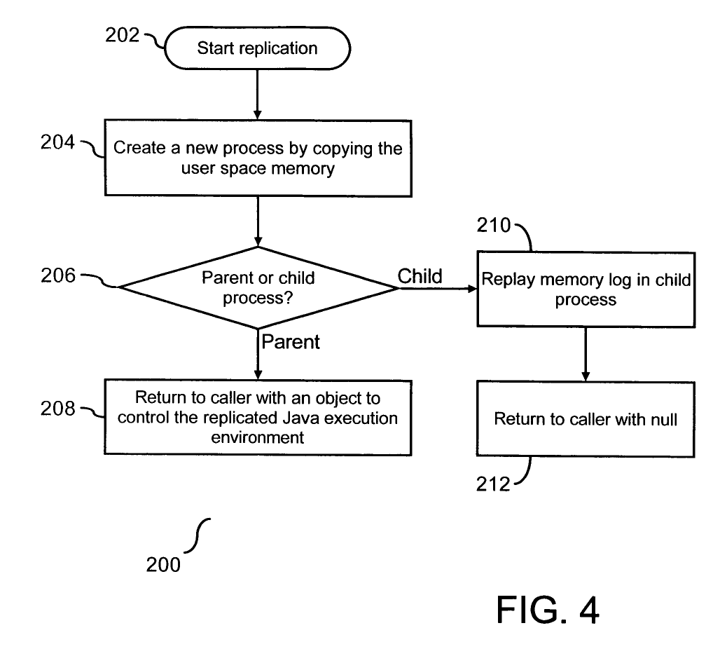

However, the process of replicating system resources shown in FIGS. 3a and 3b, such as threads, does not include replication of operating system monitors or other resources that reside in the kernel space of the operating system and cannot be dumped. An alternative to utilization of a dump request to place the state of a system resource of the parent process in a location that can be replicated is creation of a memory log of the activities to a system resource of the parent process. This method is used for resources whose internal states in the kernel memory cannot be retrieved. FIG. 4 is a flow chart (200) illustrating an example of storing operating system monitors in a memory log in user space memory according to a second embodiment of the invention. Before the initiation of replication (202), a memory log has already been created for placing the state of operating system monitors of the parent process in a location that can be efficiently replicated. Each thread continuously posts activities of operating system monitors into the memory log as part of the processing step. There is no requirements for special logging during the replication process because the memory log already exists as part of the processing step. Each thread which posts the state in the memory log posts the operating system monitors and other system resources whose internal states cannot otherwise be retrieved. Upon creation of a child process from the parent process, the user space memory of the parent process is replicated (204). The memory log maintained in the parent process is stored in the user space memory and is copied to the child process as part of the replication process.

Following the replication process at step (204), a test is conducted to determine continued processing of the parent process or start of a child process (206). In the parent process, a return of an object to the caller is conducted to control the replicated JAVA execution environment (208). In the child process, the memory log copied from the user space memory of the parent process is replayed (210). Upon completion of replay of the memory log, the child process is initialized with the state of the operating system monitors and other system resources maintained in the memory log. A null value is returned following completion of the log replay (212). Accordingly, the state of operating system monitors and other system resources maintained in the memory log are replicated in the user memory space and replayed in the child process.

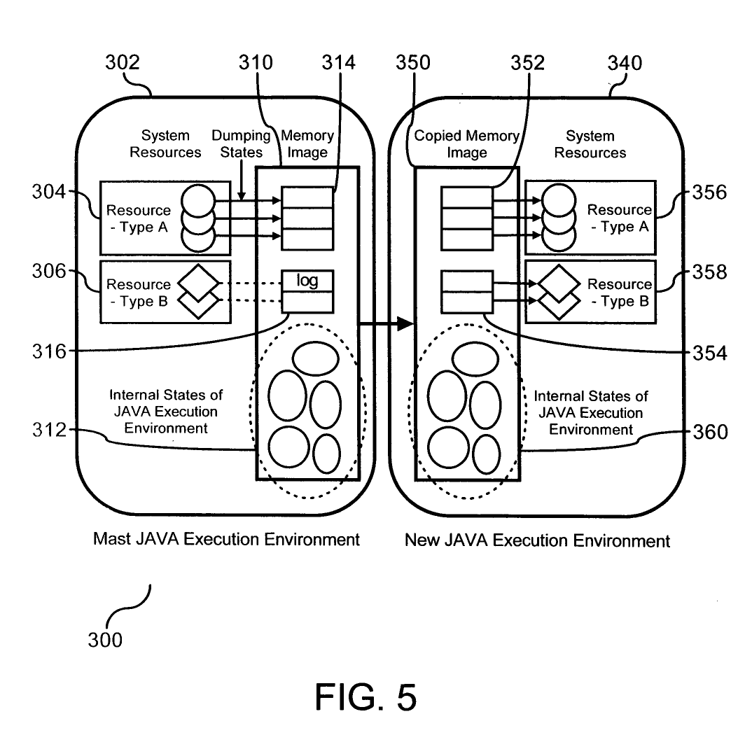

Usually, the two embodiments described above, replicating threads and a memory log of operating system monitors are used in combination. For system resources whose internal states can be retrieved, dumping method shown in the first embodiment is used. Similarly, for system resources whose internal states cannot be retrieved, logging method shown in the second embodiment is used. FIG. 5 is a block diagram (300) illustrating the use of replicating threads, i.e., dumping, and creating a memory log of operating system monitors, i.e., logging, for regenerating resources. As shown, there is an initialized JAVA application (302) at first. The initialized JAVA application (302) has two categories of system resources, shown as resource type A (304) and resource type B (306). Resource type A refers to threads or other system resource that may be replicated through a dumping process, and resource type B refers to operating system monitors or other system resources that may not be replicated by a dumping process and must be replicated by placement in a memory log. In addition to the resources (304) and (306), the initialized JAVA application maintains a memory image (310), which has therein internal states of the JAVA execution environment (312), the dumped states of the threads or other system resources that are subject to replication by dumping (314), and the memory log of operating system monitors and other system resources that are subject to replication by logging (316). Upon creation of the new process (340), the memory image (310) of the initialized JAVA application (302) is copied to the new process and resides therein (350). The copied memory image (350) includes a copy of the states of the threads or other system resources of the initialized JAVA application (352), and a copy of the memory log of operating system monitors and other system resources of the initialized JAVA application (354). Threads are created by the copied dumped image (352) and restarted as shown in FIG. 3b, and are shown at (356) residing outside of the memory image (350). Similarly, the system resources in the copy of the memory log (354) are recreated by replaying the memory log in the new process (340), and are shown residing outside of the memory image (350) at (358) following the memory log replay. The internal states of the JAVA execution environment (360) remain in the copied memory image (350). Once the recreation of the threads and replay of the memory log is complete, the new process will have been initialized as the replication of the parent JAVA application. Accordingly, the JAVA replication process incorporates replication of threads and operating system monitors through two different processes

The recreated system resources in the child process may have different descriptors (handles) from those in the parent process. To resolve disputes associated with identifying the descriptors, a mapping table may be used to virtualize a reference of the system resource instead of directly using the descriptor in the JAVA execution environment. Following either dumping or logging of each system resource from the parent process in steps (156) and (206), respectively, the mapping table is modified in the child process to contain the descriptor of newly recreated resources.

### Advantages over the Prior Art

The present invention provides a method and system for replicating an initialized version of a JAVA application which includes replication of system resources that may only be present in the kernel layer of the operating system. The state of system resources is either continuously logged into user space memory or dumped in user space memory prior to replication of the user space memory into a child application. Following dumping of the state in user space memory, an image of the user space memory is copied into a new child process. Thereafter, the system resources copied from the user space memory are recreated in the child process through either restored from the dump or replayed from a memory log. Experimentation of the process disclosed herein has shown replication of a JAVA application to include less than 10% of the time required to initialize a JAVA application normally.

### ALTERNATIVE EMBODIMENTS

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method for starting a JAVA application comprising:
copying a memory image of a process executing a JAVA execution environment having a completed initialization; and
recreating a system resource not present in said copied memory image in a new process.

2. The method of claim 1, further comprising recording a state of a system resource into memory in said initialized environment prior to copying said memory image of a process.

3. The method of claim 2, further comprising recreating said recorded state of a system resource in said new process.

4. The method of claim 1, further comprising recording access of a system resource in said initialized environment prior to copying said memory image of a process, and replaying said recorded access of system resource into said copied memory image following recreation of said system resource in said new process.

5. The method of claim 1, wherein the step of recreating a system resource not present in said copied memory image includes virtualizing a reference of said system resource.

6. The method of claim 1, wherein the step of copying a memory image of a process includes reducing memory overhead by discriminating data allocation.

7. A computer system comprising:
a process executing a JAVA execution environment having a completed initialization;
a master image manager adapted to copy a memory image of said process; and
a copy image manager adapted to recreate a system resource not present in said copied memory image in a new process.

8. The system of claim 7, further comprising a system manager adapted to record a state of said system into said initialized environment prior to said master image manager copying a memory image of said process.

9. The system of claim 8, wherein said system manager is adapted to recreate said recorded state of a system in said new process.

10. The system of claim 7, further comprising a recordation manager adapted to record access of a system resource in said initialized environment prior to said master image manager copying a memory image of said process, and to replay said recorded access of a system resource into said copied memory image following recreation of said system resource in said new process.

11. The system of claim 7, wherein said copy image manager is adapted to virtualize a reference of said system resource.

12. The system of claim 7, wherein said copy image manager is adapted to reduce memory overhead by discriminating data allocation.

13. An article comprising:
a computer-readable signal-bearing medium;
means in the medium for copying a memory image of a process executing a JAVA execution environment having a completed initialization; and
means in the medium for recreating a system resource not present in said copied memory image in a new process.

14. The article of claim 13, wherein the medium is selected from a group consisting of:
a recordable data storage medium, and a modulated carrier signal.

15. The article of claim 13, further comprising means in the medium for recording a state of a system resource into memory in said initialized environment prior to copying said memory image of a process.

16. The article of claim 15, further comprising means in the medium for recreating said recorded state of a system resource in said new process.

17. The article of claim 13, further comprising means in the medium for recording access of said system resource in said initialized environment prior to copying said memory image of a process, and replaying said recorded access of said system resource into said copied memory image following recreation of said system resource in said new process.

18. The article of claim 13, wherein said means for recreating a system resource not present in said copied memory image includes virtualizing a reference of said system resource.

19. The article of claim 13, wherein said means for copying a memory image of a process includes reducing memory overhead by discriminating data allocation.
